(19) United States
(12) Patent Application Publication
(10) Pub. No.: US 2024/0053664 A1
(43) Pub. Date: Feb. 15, 2024

(54) PROJECTION LAMP

(71) Applicant: DANDAN TAN, ZIYANG (CN)

(72) Inventor: JINBO SHU, NINGBO (CN)

(21) Appl. No.: 17/902,292

(22) Filed: Sep. 2, 2022

(30) Foreign Application Priority Data
Aug. 10, 2022 (CN) 2022220964654

(51) Int. Cl. F21V 14/08; F21V 21/08; F21V 14/02

(52) U.S. Cl. CPC F21V 14/08; F21V 21/0824; F21V 14/02; F21W 2121/00

(57) ABSTRACT

A projection lamp includes a light source, a spotlight assembly, a film projection assembly, a lens, and a motor. The spotlight assembly is disposed in a light emitting direction of the light source, and the spotlight assembly includes condensing lenses directly facing the light source. The film projection assembly is disposed on one side, distal from the light source, of the spotlight assembly. The lens is disposed on one side, distal from the light source, of the film projection assembly. The lens includes a plurality of lens structures, and each of the plurality of lens structures includes a first surface facing the film projection assembly. The first surface is an arc surface protruding towards the film projection assembly. An output shaft of the motor is penetrated through the spotlight assembly and the film projection assembly. The output shaft of the motor is fixedly connected to the lens.

### TECHNICAL FIELD

The present disclosure relates to a technical field of projection equipment, and in particular to a projection lamp.

### BACKGROUND

With the development and application of optical technology, a wide variety of projection lamps are developed, which decorates and beatifies living environment for people. However, the projection lamps in the prior art are almost static projections, and are less in dynamic projections.

Most of the projection lamps in the prior art provide a motor driving assembly to drive films to rotate, thereby achieving dynamic projection effects. However, when the motor driving assembly drives the films to rotate, a projected pattern is rotated around one single central point, the dynamic projection effects of which is poor.

### SUMMARY

One embodiment of the present disclosure provides a projection lamp, which has good dynamic projection effects.

The projection lamp of the embodiment of the present disclosure includes a light source, a spotlight assembly, a film projection assembly, a lens, and a motor. The spotlight assembly is disposed in a light emitting direction of the light source, and the spotlight assembly includes condensing lenses directly facing the light source. The film projection assembly is disposed on one side, distal from the light source, of the spotlight assembly. The lens is disposed on one side, distal from the light source, of the film projection assembly. The lens includes a plurality of lens structures, and each of the plurality of the lens structures includes a first surface facing the film projection assembly. The first surface is an arc surface protruding towards the film projection assembly. An output shaft of the motor penetrates through the spotlight assembly and the film projection assembly. The output shaft of the motor is fixedly connected to the lens. The motor drives the lens to rotate.

Furthermore, the projection lamp further includes a base, a lamp housing, and a connecting assembly. The light source, the film projection assembly, the lens, and the motor are all disposed in the lamp housing. A first end of the connecting assembly is connected to the lamp housing. A second end of the connecting assembly is connected to the base. The lamp housing is rotated with respect to the base through the connecting assembly.

Furthermore, the lamp housing includes a first threaded seat. The first threaded seat protrudes towards the base. An accommodating space is formed in the first threaded seat. The connecting assembly includes a connecting component, a ball-shaped cover, and a first nut. The connecting component is connected to the base. The ball-shaped cover is connected to one end, facing the lamp housing, of the connecting component. The ball-shaped cover is disposed in the accommodating space. The ball-shaped cover abuts against the first threaded seat. The first threaded seat rotates with respect to the ball-shaped cover. The first nut is covered with the ball-shaped cover. The first nut is screwed to the first threaded seat.

Furthermore, the lamp housing includes a protruding portion protruding towards the base. The connecting assembly includes a connecting component, a fixing screw, and a second nut. A first end of the connecting component is connected to the base, and a second end of the connecting component is disposed with respect to the protruding portion. The protruding portion rotates with respect to the connecting component. The fixing screw penetrates through the connecting component and the protruding portion. The second nut is screwed to the fixing screw.

Furthermore, the projection lamp further includes a stake. The stake is detachably connected to one side, distal from the lamp housing, of the base. One end, distal from the base, of the stake is a tip.

Furthermore, the projection lamp further includes a connecting wire assembly. The connecting wire assembly includes a plug seat, a connecting wire, and a third nut. The plug seat includes a plug housing, a plug, and a transformer. The plug is penetrated through the plug housing. The transformer is disposed in the plug housing. The transformer is electrically connected to the plug. A second threaded seat is disposed on one side, distal from the plug, of the plug seat. A connecting port is defined in the second threaded seat. The connecting port is electrically connected to the transformer. The connecting wire includes a first terminal and a second terminal, and the first terminal and the second terminal are oppositely disposed and are electrically connected. The first terminal is electrically connected to the connecting port. The light source and the motor are electrically connected to the second terminal. The third nut is configured to cover at least part of the first terminal and is screwed to the second threaded seat.

Furthermore, the connecting wire assembly further includes a first sealing ring, and the first sealing ring is disposed between the third nut and the second threaded seat.

Furthermore, the lens further includes a lens body. The output shaft is fixedly connected to a center of the lens body. The plurality of the lens structures is uniformly disposed around the output shaft.

Furthermore, the output shaft is penetrated through a center of the spotlight assembly. The film projection assembly includes a pressing plate and at least one projection sheet. The at least one projection sheet includes a plurality of patterns, and the plurality of the patterns are uniformly disposed around the output shaft. The pressing plate is pressed on one side, facing away from the spotlight assembly, of the at least one projection sheet.

Furthermore, the lamp housing includes a first end and a second end, and the first end and the second end are oppositely disposed. The projection lamp further includes a rear cover, a second sealing ring, a lamp cover, a glass, and a third sealing ring. The rear cover is disposed at the first end of the lamp housing. The second sealing ring is disposed between the rear cover and the lamp housing. The lamp cover is covered at the second end of the lamp housing. The glass is clamped between the lamp housing and the lamp cover. The third sealing ring is disposed between the glass and the lamp housing.

In one embodiment of the present disclosure, an optical signal emitted by the light source sequentially passes through the condensing lenses, the film projection assembly, and the lens, and the motor drives the lens to rotate. Because the lens includes the plurality of the lens structures, the first surface facing the film projection assembly of each of the lens structures is an arc surface protruding towards the at least one projection sheet, which drives an edge of the arc surface of each of the lens structures, a center of the arc surface of each of the lens structures, and the edge of the arc surface of each of the lens structures circularly move with respect to the projection at least one sheet. That is, the optical signal, passing through a same position of the projection sheet, is circulated through the edge of the arc surface of each of the lens structures, the center of the arc surface of each of the lens structures, and the edge of the arc surface of each of the lens structures. Therefore, the patterns projected by the projection lamp are gradually changed from a periphery to a center and brightness of the patterns is changed from dark to bright, and then the patterns are gradually changed back from the center to the periphery and the brightness of the patterns is changed back from bright to dark, so that the projection lamp achieves good dynamic projection effects.

### BRIEF DESCRIPTION OF DRAWINGS

In order to more clearly illustrate technical solutions in embodiments of the present disclosure, drawings required in description of the embodiments are briefly described below. Obviously, the drawings in the following description are merely some embodiments of the present disclosure, and for a person skilled in art, other drawings are obtained according to the drawings without creative efforts.

For a more complete understanding of the present disclosure and beneficial effects thereof, the following description is made with reference to the accompanying drawings, in which like reference numerals designate like portions throughout the following description.

FIG. 1 is a structural schematic diagram of a projection lamp according to one embodiment of the present disclosure.

FIG. 2 is an exploded schematic diagram of the projection lamp according to one embodiment of the present disclosure.

FIG. 3 is another structural schematic diagram of the projection lamp according to one embodiment of the present disclosure.

FIG. 4 is another exploded schematic diagram of the projection lamp according to one embodiment of the present disclosure.

FIG. 5 is a structural schematic diagram of a connecting wire assembly according to one embodiment of the present disclosure.

FIG. 6 is a structural schematic diagram of a lens according to one embodiment of the present disclosure.

FIG. 7 is a structural schematic diagram of a motor according to one embodiment of the present disclosure.

FIG. 8 is a structural schematic diagram of a partial structure of the projection lamp according to one embodiment of the present disclosure.

FIG. 9 is a structural schematic diagram of a spotlight assembly of the projection lamp according to one embodiment of the present disclosure.

FIG. 10 is a structural schematic diagram of a light source of the projection lamp according to one embodiment of the present disclosure.

FIG. 11 is a structural schematic diagram of at least one projection sheet of the projection lamp according to one embodiment of the present disclosure.

Reference number in the drawings: 1. first sealing ring; 2. plug seat; 3. screws; 4. rear cover; 5. second sealing ring; 6. screws; 7. motor; 71. output shaft; 8. screws; 9. light source; 91. LED lamp beads; 92. lamp panel; 10. screws; 11. spotlight assembly; 12. projection sheets; 13. pressing plate; 14. screws; 15. lens; 151. lens structures; 152. lens body; 16. screw; 17. screws; 18. lamp housing; 19. sealing components; 20. third sealing ring; 21. glass; 22. lamp cover; 23. first nut; 24. ball-shaped cover; 25. screw; 26. connecting component; 27. base; 28. stake; 29. second terminal; 30. connecting wire; 31. first terminal; 32. third nut; 33. fixing screw; 34. second nut.

### DETAILED DESCRIPTION

Technical solutions in embodiments of the present disclosure are clearly and completely described below with reference to accompanying drawings in the embodiments of the present disclosure. Obviously, the described embodiments are only a part of the embodiments of the present disclosure, rather than all of the embodiments. All other embodiments obtained by a person skilled in art based on the embodiments of the present disclosure without creative efforts shall fall within a protection scope of the present disclosure.

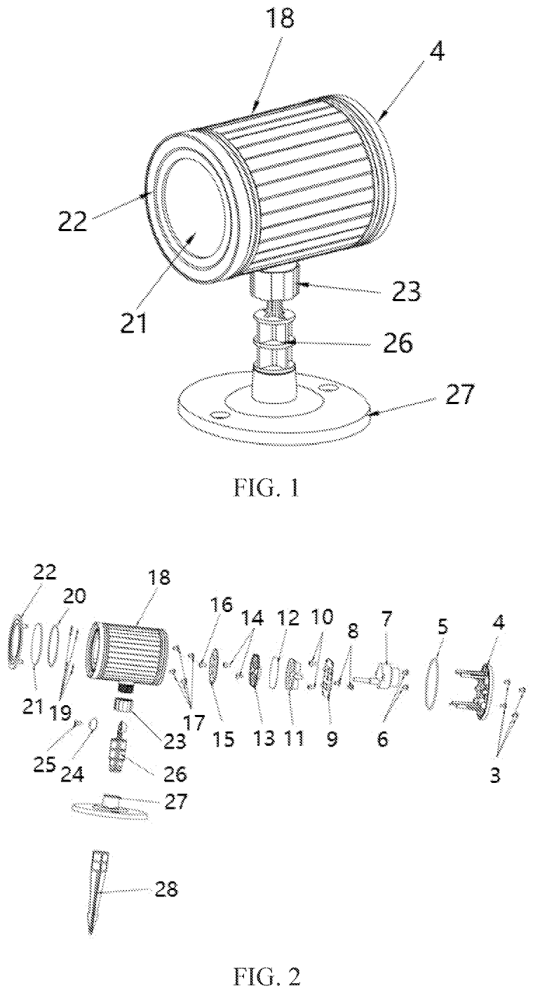

The embodiments of the present disclosure provide a projection lamp, please refer to FIG. 1 and FIG. 2. FIG. 1 is a structural schematic diagram of a projection lamp according to one embodiment of the present disclosure. FIG. 2 is an exploded schematic diagram of the projection lamp according to one embodiment of the present disclosure. The projection lamp includes a light source 9, a spotlight assembly 11, a film projection assembly, a lens 15, and a motor 7. The light source 9 provides an optical signal, and the light source 9 is an LED lamp or other types of lamps. The spotlight assembly 11 is disposed in a light emitting direction of the light source 9, and the spotlight assembly 11 includes condensing lenses directly facing the light source. The condensing lenses aggregate the optical signal emitted by the light source 9, and then projects the aggregated optical signal onto the at least one projection sheet 12 of the film projection assembly. The film projection assembly is disposed on one side, distal from the light source 9, of the spotlight assembly 11. The film projection assembly includes one or more projection sheets 12. Characters and/or patterns are provided on the projection sheets 12. After the optical signal shines on the at least one projection sheet 12, texts and/or patterns with respect to the at least one projection sheet 12 are generated. The lens 15 is disposed on one side, distal from the light source 9, of the film projection assembly. The lens 15 includes a plurality of lens structures 151, and each of the plurality of the lens structures 151 includes a first surface facing the film projection assembly. The first surface is an arc surface protruding towards the film projection assembly. The lens structures 151 change transmission route of the optical signal, for example, the lens structures 151 diffuse the optical signal. An output shaft 71 of the motor 7 is penetrated through the film projection assembly. The output shaft 71 of the motor 7 is fixedly connected to the lens 15. The motor 7 drives the lens 15 to rotate.

The optical signal emitted by the light source 9 sequentially passes through the condensing lenses, the film projection assembly, and the lens 15, and the motor 7 drives the lens 15 to rotate. Because the lens 15 includes the plurality of the lens structures 151, the first surface facing the film projection assembly of each of the lens structures 151 is an arc surface protruding towards the projection sheets 12. When the optical signal shines on the convex arc surface of each of the lens structures 151, the lens structures 151 refract the optical signal to a certain extent. Therefore, when the motor 7 drives the plurality of the lens structures 151 to rotate, an edge of the arc surface of each of the lens structures 151, a center of the arc surface of each of the lens structures 151, and the edge of the arc surface of each of the lens structures 151 circularly move with respect to the projection sheets 12. That is, the optical signal, passing through a same position of the projection sheets 12, is circulated through the edge of the arc surface of each of the lens structures 151, the center of the arc surface of each of the lens structures 151, and the edge of the arc surface of each of the lens structures 151. Therefore, the patterns projected by the projection lamp are gradually changed from a periphery to a center and brightness of the patterns is changed from dark to bright, and then the patterns are gradually changed back from the center to the periphery and the brightness of the patterns is changed back from bright to dark. Compared with a projection lamp using the motor 7 to drive films to rotate, patterns of dynamic projection of the projection lamp of the embodiment are not rotated around one single central point, the projection patterns are clear, and dynamic projection effects are better, which improves customer experience.

It should be noted that the lens 15 is of an integral structure, a plurality of independent lens structures 151 are disposed on the lens 15, and each of the plurality of lens structures 151 independently realizes change of light. For example, obtaining a substrate first, and then machining two opposite surfaces of the substrate, thereby machining the lens 15 having the plurality of the lens structures 151. For another example, disposing the plurality of the lens structures 151 first, and then fixedly connecting the plurality of the lens structures 151 through same materials as the lens structures 151 or other high light-transmitting materials to form the lens 15.

The projection lamp further includes a lamp housing 18, a base 27, and a connecting assembly. The lamp housing 18 is configured as a main carrier of the projection lamp. The light source 9, the film projection assembly, the lens 15, and the motor 7 are all disposed in the lamp housing 18. The lamp housing 18 is configured to accommodate a plurality of components, and the lamp housing 18 is configured to protect various components in the lamp housing 18. The base 27 is configured as a supporting base 27 of the projection lamp, so that the projection lamp is conveniently placed on a table top, a cabinet, etc. A first end of the connecting assembly is connected to the lamp housing 18, a second end of the connecting assembly is connected to the base 27, and the lamp housing 18 rotates with respect to the base 27 through the connecting assembly, so as to adjust an angle of the lamp housing 18 with respect to the base 27, which is convenient for a user to adjust positions of images projected by the projection lamp.

Furthermore, the lamp housing 18 includes a first threaded seat. The first threaded seat protrudes towards the base 27. An accommodating space is formed in the first threaded seat. The connecting assembly includes a connecting component 26, a ball-shaped cover 24, and a first nut 23. The connecting component 26 is connected to the base 27. The ball-shaped cover 24 is connected to one end, facing the lamp housing 18, of the connecting component 26. The ball-shaped cover 24 is disposed in the accommodating space. The ball-shaped cover 24 abuts against the first threaded seat. The first threaded seat rotates with respect to the ball-shaped cover 24. The first nut 23 is covered with the ball-shaped cover 24. The first nut 23 is screwed to the first threaded seat. When the first threaded seat rotates with respect to the ball-shaped cover 24, it should be understood that when the lamp housing 18 moves with respect to the base 27, the lamp housing 18 moves downward or upward or leftward or rightward with respect to the base 27. Because the ball-shaped cover 24 is a ball body, the lamp housing 18 rotates 360 degrees with respect to the base 27. Therefore, the lamp housing 18 rotates in any direction to adjust position with respect to the base 27, and the lamp housing 18 rotates to drive all components in the lamp housing 18 to rotate, so that the images projected by the projection lamp are changed to any direction, which improves rotation flexibility of the projection lamp, and is convenient for the user to use.

Exemplarily, the first threaded seat is of a columnar structure, and a threaded structure is disposed on an outer surface of the first threaded seat. One or more openings are defined on one end, facing the base 27, of the first threaded seat, where the one or more openings are not shown in the drawings. The one or more openings extend from the first threaded seat towards an edge of the base 27 and towards the lamp housing 18, so that one end, facing the base 27, of the first threaded seat is supported to open. When the first nut 23 is not screwed to the first threaded seat, the ball-shaped cover 24 is disposed in the accommodating space of the first threaded seat. Moreover, the lamp housing 18 is freely rotated with respect to the base 27 through the threaded seat and the ball-shaped cover 24. After determining a relative position of the lamp housing 18 and the base 27, the first threaded seat is screwed to the first nut 23. At this time, the first threaded seat is contracted and fixed to the ball-shaped cover 24, so that the first threaded seat and the ball-shaped cover 24 are fixedly connected. That is, the lamp housing 18 is fixed at a current angle. It is further understood that the first threaded seat is supported to open through unlocking the first nut 23 and the first threaded seat. At this time, the lamp housing 18 rotates in any direction with respect to the ball-shaped cover 24 and the base 27. After the direction is determined, the first nut 23 and the first threaded seat are screwed and locked, and the lamp housing 18 is fixed at the current angle. The ball-shaped cover 24 includes two hemispherical covers, and the two hemispherical covers are fixed on the connecting component 26 through a screw 25.

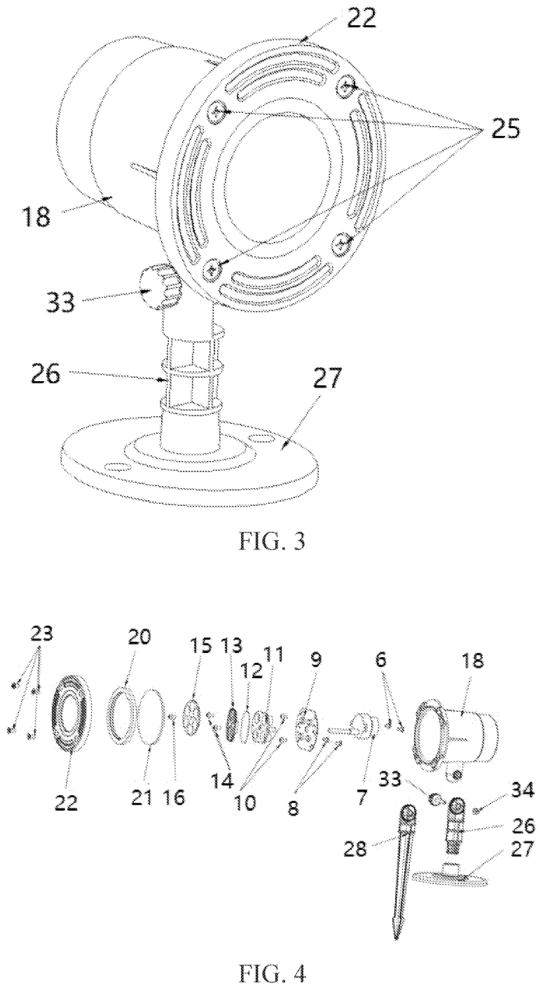

Furthermore, please refer to FIG. 3 and FIG. 4. FIG. 3 is another structural schematic diagram of the projection lamp according to one embodiment of the present disclosure. FIG. 4 is another exploded schematic diagram of the projection lamp according to one embodiment of the present disclosure. A main difference between the projection lamp of the embodiment and the projection lamp of the above-mentioned embodiment is the connecting assembly. In the embodiment, the lamp housing 18 includes a protruding portion protruding towards the base 27. The connecting assembly includes a connecting component 26, a fixing screw 33, and a second nut 34. A first end of the connecting component 26 is connected to the base 27, and a second end of the connecting component 26 is disposed with respect to the protruding portion. The protruding portion rotates with respect to the connecting component 26. The fixing screw 33 penetrates through the connecting component 26 and the protruding portion. The second nut 34 is screwed to the fixing screw 33.

Exemplarily, a first through hole is defined on the protruding portion. A second through hole, with respect to the first through hole, is defined on the connecting component 26. The fixing screw 33 penetrates through the first through hole and the second through hole. When the second nut 34 does not lock the fixing screw 33, the protruding portion rotates with respect to the connecting component 26. That is, a relative position of the protruding portion of the lamp housing 18 and the connecting component 26 is adjusted, and after the required position is adjusted, the second nut 34 and the fixing screw 33 are screwed and locked, so that the protruding portion and the connecting component 26 are fixed, and then the lamp housing 18 is fixed at the current angle.

Furthermore, the projection lamp further includes a stake 28. The stake 28 is detachably connected to one side, distal from the lamp housing 18, of the base 27. One end, distal from the base 27, of the stake 28 is a tip. The projection lamp is inserted into a required position through the stake 28, for example, the projection lamp is inserted into a grassland through the stake 28, so that the projection lamp is convenient to install.

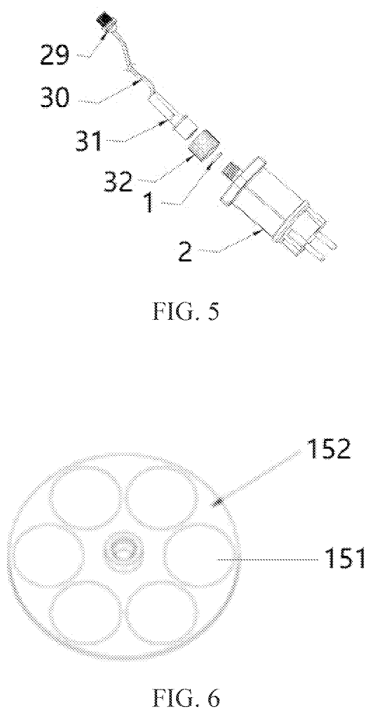

Please refer to FIG. 5, FIG. 5 is a structural schematic diagram of a connecting wire assembly according to one embodiment of the present disclosure. The projection lamp further includes a connecting wire assembly. The connecting wire assembly includes a plug seat 2, a connecting wire 30, and a third nut 32. The plug seat 2 includes a plug housing, a plug, and a transformer. The plug is penetrated through the plug housing. The transformer is disposed in the plug housing. The transformer is electrically connected to the plug. A second threaded seat is disposed on one side, distal from the plug, of the plug seat 2. A connecting port is defined in the second threaded seat. The connecting port is electrically connected to the transformer. The connecting wire 30 includes a first terminal 31 and a second terminal 32, and the first terminal 31 and the second terminal 32 are oppositely disposed and are electrically connected. The first terminal 31 is electrically connected to the connecting port. The light source 9 and the motor 7 are electrically connected to the second terminal 29. The third nut 32 is configured to cover at least part of the first terminal 31 and is screwed to the second threaded seat.

Furthermore, the connecting wire assembly further includes a first sealing ring 1, and the first sealing ring 1 is disposed between the third nut 32 and the second threaded seat. The first sealing ring 1 improves waterproof performance between the third nut 32 and the second threaded seat, that is, the waterproof performance of the connecting wire assembly is improved. The first sealing ring 1 is an O-shaped sealing ring.

Please refer to FIG. 6, FIG. 6 is a structural schematic diagram of a lens according to one embodiment of the present disclosure. Optionally, the lens 15 further includes a lens body 152. The output shaft 71 is fixedly connected to a center of the lens body 152. The plurality of the lens structures 151 are uniformly disposed around the output shaft 71. When the output shaft 71 drives the lens body 152 to rotate, a plurality of projections on the lens body 152 rotate around the output shaft 71, so that the arc surface edge of each of the plurality of the lens structures 151 and the center of the arc surface can be circularly moved with respect to the projection sheet 12, which makes an edge of the arc surface of each of the plurality of the lens structures 151, a center of the arc surface of each of the plurality of the lens structures 151, and the edge of the arc surface of each of the plurality of the lens structures 151 circularly move with respect to the at least one projection sheet 12. That is, the optical signal, passing through a same position of the projection sheets 12, is circulated through the edge of the arc surface of each of the plurality of the lens structures 151, the center of the arc surface of each of the plurality of the lens structures 151, and the edge of the arc surface of each of the plurality of the lens structures 151. Therefore, the patterns projected by the projection lamp are gradually changed from a periphery to a center and brightness of the patterns is changed from dark to bright, and then the patterns are gradually changed back from the center to the periphery, and the brightness of the patterns is changed back from bright to dark, so that the projection lamp achieves good dynamic projection effects. The lens structures 151 and the lens body 152 are of an integrated structure. For example, the plurality of lens structures 151 and the lens body 152 are formed through performing different processing in different regions of a same substrate. The plurality of the lens structures 151 and the lens body 152 are further of split structures, and the lens structures 151 are disposed on the lens body 152.

Please refer to FIG. 7, FIG. 7 is a structural schematic diagram of a motor according to one embodiment of the present disclosure. The output shaft 71 of the motor 7 is a central shaft of the motor 7, and the output shaft 71 drives the plurality of the lens structures 151 to circulate with respect to the projection sheets 12. The output shaft 71 of the motor 7 is further an eccentric shaft of the motor 7, so that the plurality of the lens structures 151 are driven to circulate with respect to the projection sheets 12, and at the same time, the plurality of the lens structures 151 have a certain offset with respect to the projection sheets 12, thereby improving the dynamic projection effects.

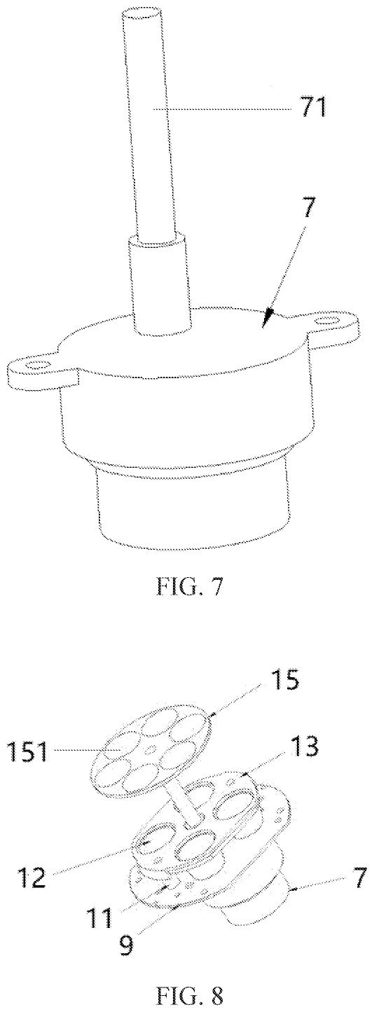

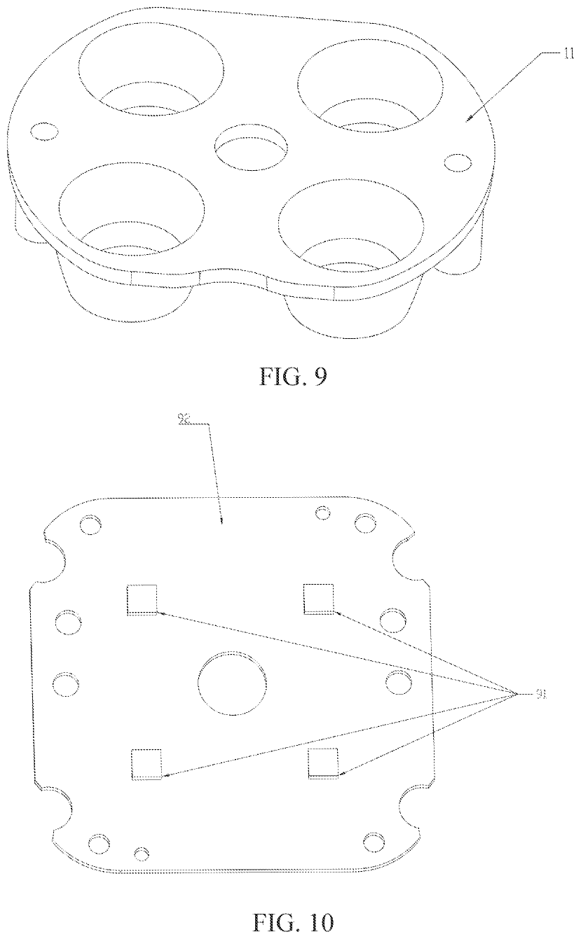

Please refer to FIG. 1, and with reference to FIG. 8 and FIG. 9, FIG. 8 is a structural schematic diagram of a partial structure of the projection lamp according to one embodiment of the present disclosure. FIG. 9 is a structural schematic diagram of a spotlight assembly of the projection lamp according to one embodiment of the present disclosure. The output shaft 71 is penetrated through a center of the spotlight assembly 11. The film projection assembly includes a pressing plate 13 and projection sheets 12. Each of the projection sheets 12 includes a plurality of patterns, and the plurality of the patterns are uniformly disposed around the output shaft 71. The pressing plate 13 is pressed on one side, facing away from the spotlight assembly 11, of the projection sheets 12. The spotlight assembly 11 is screwed and fixed to the light source 9 through first screws 8.

A plurality of channels is defined on the spotlight assembly 11. The spotlight assembly includes a plurality of the condensing lenses. Each of the plurality of the condensing lenses is disposed in each of the plurality of the channels. Each of the plurality of the channels matches with one light emitting point of the light source 9. Each of the plurality of the channels further matches with a pattern of the projection sheets 12.

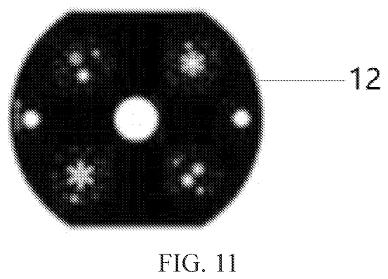

Exemplarily, please refer to FIG. 10 and FIG. 11. FIG. 10 is a structural schematic diagram of a light source of the projection lamp according to one embodiment of the present disclosure. FIG. 11 is a structural schematic diagram of projection sheets of the projection lamp according to one embodiment of the present disclosure. The light source 9 includes a lamp panel 92 and four LED lamp beads 91, and the four LED lamp beads 91 are disposed on the lamp panel 92. Four channels are defined on the spotlight assembly 11. Each of the four channels matches with each of the four LED lamp beads 91. Each of the plurality of the condensing lenses and a pattern of the projection sheets 12 are further defined in each of the four channels. The condensing lenses are configured to gather the optical signals emitted by the LED lamp beads 91. The aggregated optical signal passes through the patterns of the projection sheets 12 defined at outlets of the four channels, and then the plurality of the rotating lens structures 151 is rotated to realize dynamic projection. The LED lamp beads 91 are configured as the main light source 9, so that merely less light source 9 may meet projection requirements. The lamp panel 92 is an aluminum substrate or other substrate structure. It should be understood that the projection sheets 12 are further called films. The film projection assembly further includes a plurality of the projection sheets, and each of the plurality of projection sheets matches with one of the LED lamp beads.

The number of the lens structures 151 and the number of the patterns of the projection sheets 12 are set as required. For example, the number of the lens structures 151 is six, and the number of the patterns of the projection sheets 12 is four. For another example, the number of the lens structures 151 is eight, and the number of the patterns of the projection sheets 12 is four.

The motor 7 is disposed on a back surface, distal from the projection sheets 12, of the lamp panel 92. The motor 7 and the lamp panel 92 is fixedly connected through second screws 6. The spotlight assembly 11 is fixed on a front surface, facing the projection sheets 12, of the lamp panel 92. The projection sheets 12 are disposed on the spotlight assembly 11. The pressing plate 13 presses the projection sheets 12, and the pressing plate 13 is fixedly connected to the spotlight assembly 11. For example, the pressing plate 13 and the spotlight assembly 11 are screwed and fixedly connected through the screws 14, or the pressing plate 13 and the spotlight assembly 11 are further clamped fixedly connected or inserted fixedly connected, so as to clamp and fix the projection sheets 12 from two sides of the projection sheets 12. The output shaft 71 and the lens 15 of the motor 7 are further fixedly connected through a third screw 16.

In some embodiments, the lamp panel 92 is fixed inside the lamp housing 18. For example, four positioning columns are disposed in the lamp housing 18, and the lamp panel 92 is fixed on the four positioning columns. For another example, the lamp panel 92 is screwed and fixed to the rear cover 4 through fourth screws 10.

Please refer to FIG. 1, the lamp housing 18 includes a first end and a second end, and the first end and the second end are oppositely disposed. The projection lamp further includes a rear cover 4 and a second sealing ring 5. The rear cover 4 is covered at a first end of the lamp housing 18. The second sealing ring 5 is disposed between the rear cover 4 and the lamp housing 18. The second sealing ring 5 improves waterproof performance between the rear cover 4 and the lamp housing 18. The rear cover 4 is screwed and fixed to the lamp housing 18 through fifth screws 3. The second sealing ring 5 is a sealing component formed by foaming silica gel, plastic, plastomer, or other materials.

The projection lamp further includes a lamp cover 22, a glass 21, and a third sealing ring 20. The lamp cover 22 is covered at a second end of the lamp housing 18. The glass 21 is clamped between the lamp housing 18 and the lamp cover 22. The glass 21 does not affect the projection effects of the projection lamp 22, the glass 21 protects components in the projection lamp 22, and meanwhile, the glass 21 achieves overall waterproof and dustproof effects of the projection lamp 22. The third sealing ring 20 is disposed between the glass 21 and the lamp housing 18. The third sealing ring 20 improves waterproof performance between the glass 21 and the lamp housing 18. The third sealing ring 20 is a sealing component made of foaming silica gel, plastic, plastomer, or other materials. The lamp cover 22 and the lamp housing 18 are screwed and fixed through sixth screws 17. Specifically, hollow screw columns are disposed on the lamp housing 18. The screws 17 are disposed in the hollow screw columns, and the sixth screws 17 are screwed and fixed to the lamp cover. Sealing components 19 are disposed in the hollow screw columns. Each of the sealing components 19 is an O-ring to match with each of the hollow screw columns.

The projection lamp of the embodiment of the present disclosure is provided with fewer accessories and is simple in production and installation, which greatly reduces production installation time and production cost. In addition, the projection lamp is small in size, low in transportation cost, simple in internal structure, and long in service life. The projection lamp of the embodiment of the present disclosure overcomes problems in the prior art that the projection lamp basically has clear patterns but projects a relatively few numbers of patterns, or there are many patterns but unclear or no patterns.

The projection lamps provided by the embodiments of the present disclosure are described in detail above. Specific examples are used herein to illustrate principles and implementations of the present disclosure, and descriptions of the above embodiments are only configured to help understand methods and core ideas of the present disclosure. Meanwhile, for a person skilled in the art, according to ideas of the present disclosure, there are changes in the specific implementations and application scopes. In conclusion, contents of the specification are not to be construed as limiting the present disclosure.

What is claimed is:

1. A projection lamp, comprising:
a light source;
a spotlight assembly;
a film projection assembly;
a lens; and
a motor;
wherein the spotlight assembly is disposed in a light emitting direction of the light source, and the spotlight assembly comprises condensing lenses directly facing the light source; the film projection assembly is disposed on one side, distal from the light source, of the spotlight assembly; the lens is disposed on one side, distal from the light source, of the film projection assembly; the lens comprises a plurality of lens structures, each of the plurality of the lens structures comprises a first surface facing the film projection assembly, the first surface is an arc surface protruding towards the film projection assembly; an output shaft of the motor penetrates through the spotlight assembly and the film projection assembly, the output shaft of the motor is fixedly connected to the lens, and the motor drives the lens to rotate;
wherein the output shaft is penetrated through a center of the spotlight assembly; the film projection assembly comprises a pressing plate and at least one projection sheet; the at least one projection sheet comprises a plurality of patterns, the plurality of the patterns is uniformly disposed around the output shaft, and the pressing plate is pressed on one side, facing away from the spotlight assembly, of the at least one projection sheet;
an optical signal emitted by the light source sequentially passes through the condensing lenses, the film projection assembly, and the lens; the optical signal, passing through a same position of the projection sheet, is circulated through the edge of the arc surface of each of the lens structures, the center of the arc surface of each of the lens structures, and the edge of the arc surface of each of the lens structures, patterns projected by the projection lamp are gradually changed from a periphery to a center and brightness of the patterns is changed from dark to bright, and then the patterns are gradually changed back from the center to the periphery and the brightness of the patterns is changed back from bright to dark.

2. The projection lamp according to claim 1, wherein the projection lamp further comprises:
a base;
a lamp housing; and
a connecting assembly;
the light source, the film projection assembly, the lens, and the motor are all disposed in the lamp housing; a first end of the connecting assembly is connected to the lamp housing, a second end of the connecting assembly is connected to the base, and the lamp housing is rotated with respect to the base through the connecting assembly.

3. The projection lamp according to claim 2, wherein the lamp housing comprises a first threaded seat, the first threaded seat protrudes towards the base, an accommodating space is formed in the first threaded seat; and the connecting assembly comprises:
a connecting component;
a ball-shaped cover; and
a first nut;
the connecting component is connected to the base; the ball-shaped cover is connected to one end, facing the lamp housing, of the connecting component; the ball-shaped cover is disposed in the accommodating space, the ball-shaped cover abuts against the first threaded seat; the first threaded seat rotates with respect to the ball-shaped cover; the first nut is covered with the ball-shaped cover, and the first nut is screwed to the first threaded seat.

4. The projection lamp according to claim 2, wherein the lamp housing comprises a protruding portion protruding towards the base; and the connecting assembly comprises:
a connecting component;
a fixing screw; and
a second nut;
a first end of the connecting component is connected to the base, a second end of the connecting component is disposed with respect to the protruding portion, the protruding portion rotates with respect to the connecting component; the fixing screw penetrates through the connecting component and the protruding portion; and the second nut is screwed to the fixing screw.

5. The projection lamp according to claim 2, wherein the projection lamp further comprises a stake, the stake is detachably connected to one side, distal from the lamp housing, of the base; and one end, distal from the base, of the stake is a tip.

6. The projection lamp according to claim 1, wherein the projection lamp further comprises a connecting wire assembly; and the connecting wire assembly comprises:
a plug seat;
a connecting wire; and
a third nut;
wherein the plug seat comprises a plug housing, a plug, and a transformer; the plug is penetrated through the plug housing, the transformer is disposed in the plug housing, and the transformer is electrically connected to the plug; a second threaded seat is disposed on one side, distal from the plug, of the plug seat; a connecting port is defined in the second threaded seat, the connecting port is electrically connected to the transformer; the connecting wire comprises a first terminal and a second terminal, the first terminal and the second terminal are oppositely disposed and are electrically connected; the first terminal is electrically connected to the connecting port, the light source and the motor are electrically connected to the second terminal; and the third nut is configured to cover at least part of the first terminal and is screwed to the second threaded seat.

7. The projection lamp according to claim 6, wherein the connecting wire assembly further comprises a first sealing ring, and the first sealing ring is disposed between the third nut and the second threaded seat.

8. The projection lamp according to claim 1, wherein the lens further comprises a lens body, the output shaft is fixedly connected to a center of the lens body, and the plurality of the lens structures are uniformly disposed around the output shaft.

9. (canceled)

10. The projection lamp according to claim 2, wherein the lamp housing comprises a first end and a second end, the first end and the second end are oppositely disposed; the projection lamp further comprises:
a rear cover;
a second sealing ring;
a lamp cover;
a glass; and
a third sealing ring;
the rear cover is disposed at the first end of the lamp housing; the second sealing ring is disposed between the rear cover and the lamp housing; the lamp cover is covered at the second end of the lamp housing; the glass is clamped between the lamp housing and the lamp cover; and the third sealing ring is disposed between the glass and the lamp housing.

11. The projection lamp according to claim 1, wherein a lamp panel is fixed inside the lamp housing, four positioning columns are disposed in the lamp housing, and the lamp panel is fixed on the four positioning columns.

12. The projection lamp according to claim 1, wherein a lamp panel is screwed and fixed to the rear cover through fourth screws.

13. The projection lamp according to claim 1, wherein the lens is of an integral structure, a plurality of independent lens structures are disposed on the lens, and each of the plurality of lens structures independently realizes change of light.

14. The projection lamp according to claim 1, wherein a first threaded seat is of a columnar structure, and a threaded structure is disposed on an outer surface of the first threaded seat, one or more openings are defined on one end, facing the base, of the first threaded seat, the one or more openings extend from the first threaded seat towards an edge of the base and towards the lamp housing, so that one end, facing the base, of the first threaded seat is supported to open, when a first nut is not screwed to the first threaded seat, a ball-shaped cover is disposed in an accommodating space of the first threaded seat, the lamp housing is freely rotated with respect to a base through the threaded seat and the ball-shaped cover, the lamp housing is fixed at a current angle.

15. The projection lamp according to claim 1, wherein a ball-shaped cover comprises two hemispherical covers, and the two hemispherical covers are fixed on the connecting component through a screw.

16. The projection lamp according to claim 2, wherein the lamp housing rotates in any direction to adjust position with respect to the base, and the lamp housing rotates to drive all components in the lamp housing to rotate.

17. The projection lamp according to claim 16, wherein the lamp housing moves downward or upward with respect to the base.
